(19) United States
(12) Patent Application Publication
(10) Pub. No.: US 2012/0175882 A1
(43) Pub. Date: Jul. 12, 2012

(54) Injector venturi accelerated, wind turbine

(76) Inventors: Peter John Sterling, Rancho Mirage, CA (US); Zina Sterling, Rancho Mirage, CA (US); Ketzal Sterling, Rancho Mirage, CA (US); Geoffrey Woods, Fairfield, CT (US)

(21) Appl. No.: 12/930,542

(22) Filed: Jan. 10, 2011

(51) Int. Cl. F03D 9/00

(52) U.S. Cl. 290/55; 415/1

(57) ABSTRACT

An ambient wind Accelerating Wind Turbine is disclosed which exceeds the efficiency of prior wind turbines. Unique venturi with diffuser-injectors concepts are employed to speed up ambient wind flows into a high speed propeller for power generation improvements of 75% or greater. Applicants preferred Accelerating Wind Turbine embodiment comprises; an aerodynamically contoured venturi turbine shroud with a compression venturi inlet section; a ring of rotating blades, (i.e., a propeller) ; and a rear vacuum venturi section; with diffusers-injectors strategically placed in the venturi to ensure the smooth flow of accelerated air through and rearward of the venturi. Soft bird screens are located at the venturi openings to eliminate avian deaths. The Accelerated Wind Turbine can increase the power output of a wind turbine by a factor of two or more making wind power competitive in price to fossil fuel power.

### BACKGROUND OF THE INVENTION

1. Field of Invention

The invention relates to an improved natural wind energy accelerating ducted focusing and control system of both push airflow acceleration and pull vacuum funnels-diffusers, having a number of large area, low cost reconfigurable hard shell fiberglass, carbon fiber and or sail fabric PVC coated vinyl fabric or membrane funnels, with panels which can be expanded or retracted. The ambient wind facing funnel duct mouth captures ambient wind accelerates it into a mechanical wind turbine. Additional rear facing diffuser with diverging duct funnels and diffuser rings to control boundary layer airflows, creates an additional strong rotating vacuum behind the turbine blades and further accelerates the wind through the turbine blades without causing the airflow to stall or break away.

The wind turbine consists of a machine housing located on a frame so as to rotate about its axis and receiving a generator, and a brake, and a wind powered rotor mounted in the machine housing having at least two rotor blades designed to survive and produce mechanical-electrical energy in the most hostile wind environments.

Wind energy is often used to generate electrical power using the rotation of large slow turning wind turbines to drive electrical generators. A group of generators are often referred to as wind farms. The density of wind energy, in terms of watts per square meter, is one of the highest among other forms of natural energy. This invention accelerates ambient wind speed by approximately 200-300% and converts the accelerated wind energy into electrical energy at a much lower capital and operating cost per Megawatt than current state of the art wind generators.

Using fossil fuels—coal, oil and natural gas—to make electricity dirties the world's air, consumes and pollutes water, hurts plants and animal life and creates toxic wastes.

Wind Generators are increasingly used for power generation; typically through the use of a tower-mounted 2-3 bladed turbine, which typically rotates slowly at 15-25 RPM, which rotates an electrical power generator to produce electricity.

While wind itself is a clean, inexhaustible, indigenous and abundant “free” energy resource, conventional wind generator turbines built to capture wind energy typically sit on a very tall heavy steel mast or support tower, carrying on top a very heavy weight of turbine, gearbox and generator and the very long propeller blades use fragile cantilevered beams. Because most suitable locations ambient wind speeds are slow at around 20 mph average annual wind speed, with a typical 500-600 watts per square meter of wind power density, their propeller blades are necessarily built at huge sizes, with blades often around 150-200 feet or more long, in order to produce between 1 to 5 Megawatts of power. Their size and weight makes them quite fragile, the mechanical stresses allowing for only a slow rotational speed. Many models add a large heavy gearbox to increase the slow turbine shaft speed to drive a conventional high-speed electrical generator. The turbines must be turned off in high wind speed events of 50mph or more. It is not uncommon for the entire structure to be blow over in storm weather resulting in large capital losses. At least 3 turbines have blown over in the US alone in the 3 months period of November 2009 to January 2010.

Traditional commercial scale wind generators blades are long, and require special expensive infrastructure to manufacture and transport. With a typical 100 ft blade weighing around 4.5 tons and a 177 ft blade weighing around 13 tons the weight of the blade is not proportional to the size and power rating of the machine. Each extra meter of length requires extra mechanical strength which adds further to the structure's weight and so compounds the mechanical bending and G-force problems. Additionally the bending moments across the swept area of the blade can vary considerably with a difference of several meters a second in wind speeds between the top and the bottom of the blades rotation. This all adds up to a substantial increase in fatigue, not only in the blade structure but the machines hub, bearing, drive shaft and support tower.

Traditional wind generators only extract between 25%-30% of the wind energy in the blades swept area out of a theoretical 59% maximum, as a large percentage of the ambient airflow within the propeller's swept area passes by a small number of blades without impacting the blades.

Conventional wind turbines cannot operate at wind speeds above about 50-60 mph because the long fragile blades will disintegrate.

Because of the very high capital costs, a megawatt of conventional wind generator created electricity has net cash-financing-generating costs about 2 or 4 times as much to produce as a megawatt of natural gas, coal or oil-generated electricity. Thus without government subsidies, current state of the art wind generators cannot commercially compete against gas, coal and oil. This invention changes the economics in favor of wind power by generating much more renewable energy wind powered electricity for a significantly lower capital investment.

2: Advantages of my Invention over Prior Art

Utilizing a collection of both higher cost carbon fiber, Fiberglass and-or metals as well as inexpensive materials such as, sailcloth, PVC coated vinyl fabric, or other fabric membrane panels, sailboat technology roller furling devices, airflow speed control devices and methods easily implemented to form a more powerful, cheaper wind accelerating push-pull funnels-duct diffuser assembly. The first wind-facing structure is a gentle cone angle push-funnel or duct for accelerating ambient wind speed to approximately 1.5 to 3 times ambient wind speed thereby increasing air power density by approximately 400% or more facing into the prevailing wind on the upwind side of a hard-shell shrouded turbine. The second is a diffuser-augmented pull or vacuum funnel assembly of two or more funnels and diffuser-injector rings on the downwind side of the hard shell shrouded turbine which creates a smooth airflow venturi vacuum to further accelerate the wind through the turbine to approximately 200% to 300% ambient prevailing wind speed, thus increasing power density to between 10 to 20 times ambient wind power. This is much greater wind power density increase than any state of the art accelerating wind generators

The turbine can generate significantly more power over a wider range of ambient wind speeds than prior art turbines including push only or pull only diffuser augmented turbines such as disclosed in U.S. Pat. No. 7,218,011 B2.

The funnel size to cone angle ratios and circumferential diffuser-injector rings are placed and designed so as to accelerate the ambient wind speed without causing the airflow in and around the funnel assembly to separate, collapse or break away.

The structure also contains mechanically opened and closed wind control doors and retractable panels for controlling gusts and managing the faster more powerful airflow into a wind powered electricity generating turbine. The entire structure is constructed at a net per-Megawatt cost significantly lower than current state of the art non accelerated ambient wind generators and vacuum-only wind generators.

Some embodiments include fiberglass or other hard venturi membrane material or large deployable-furling sailcloth or PVC coated vinyl fabric panels accelerating the ambient airflow, by both push airflow acceleration and pull vacuum funnels. Opening and closing funnel wall doors and panels to control the speed and amount of airflow into the turbine blades, doors to focus airflow in preferred directions and to restrict or close off turbine airflow when desired, wind speed and direction sensors and control programming and/or circuitry that tracks trends in wind direction and speed, and anticipates the need to move the facing direction of the wind-accelerating funnel to direct changing ambient wind into the funnel, and to provide at least 10 to 20 times net wind power density increases to the wind-powered turbine. Also make wind power at an ambient wind speed that is lower than could normally operate the turbine without the Improved Injector Venturi Accelerated, Wind Turbine.

What it Accomplishes
a) 200% to 300% increased wind speed equals significantly increased kinetic power density wind flows into the turbine blades of between 10 to 20 times ambient wind power density. The reason for capturing and focusing the ambient wind is because the increased speed wind carries a significantly higher power density and thus more power can be generated from smaller diameter lower-capital-cost turbine blades. A smaller faster-rotating wind turbine is mechanically much stronger and cheaper to build and maintain. While accelerating duct components are relatively cheap and simple to build.
b) Generates significantly more electrical power per dollar of capital employed than current state of the art wind power generators. A typical Improved Injector Venturi Accelerated, Wind Turbine installation using this invention will produce between 200% to 300% more electricity per dollar of capital employed than current state of the art 3-blade ambient wind generators making wind generated electricity very price competitive with any other electrical generation systems and with zero carbon emissions.
c) Innovative designs of the invention reduces turbine costs per unit of recovered power by as much as 75%.
d) Depending upon the wind characteristics of a particular wind farm location, the described wind accelerating and airflow control devices will also increase the annual turbine operating electricity generating hours by between 10% to 25% over existing uncontrolled, non accelerated airflow wind turbines, while reducing turbine maintenance costs.
e) The ability of the Improved Injector Venturi Accelerated, Wind Turbine to extract electrical power from lower wind speeds will open new geographic slower-wind speed areas to wind turbine use, such as the large Great Lakes Area of US-Canada, (only 16-17 mph average ambient wind speed). This area is estimated to be capable of delivering up to 300 Gigawatts of wind power. Using conventional slow large 3 blade turbines would result in wholesale electricity costs from the Great Lakes and similar low-speed wind areas elsewhere, of approximately 300% to 400%% higher than using this Improved Injector Venturi Accelerated, Wind Turbine invention.
f) Locating the electrical generator and smaller faster turbine closer to the ground reduces structural problems, lowers capital costs and reduces maintenance costs over existing state of the art 3-blade wind turbines.
g) The modest capital cost injected venturi airflow accelerator-controller increases the power density of any ambient air stream more than simple vacuum methods by funneling and directing the smoothed and accelerated airflow over a multi-blade air turbine using both push and pull ambient wind acceleration.
h) Reduced turbine component transportation and construction costs due to smaller, lighter air turbine blades.
i) Smaller diameter multi-bladed higher speed rotor and nacelle installed in one easy lift using a smaller crane than for conventional wind turbines.
j) A wider wind speed operating range of 10-100 mph plus ambient wind speeds, means significantly greater operating hours per year and significantly increased electricity production per unit of capital employed.
k) The focused turbine funnel outer entrances will be fitted with large soft bird nets, which will eliminate the incidence of avian deaths suffered by current state of the art unprotected wind turbine blades.
l) Airflow control doors which rotate though 45 degrees can be located immediately in front of the generator blades can be added to direct the airflow and reduce the flow during gusts or other high wind periods, thus allowing the generator to continue to generate maximum power, even when the ambient wind speed is higher than the maximum allowable wind speed over the turbine blades.
m) Preferred use of a synchronous electrical generator design means no need for expensive equipment to connect to the grid.
n) Smaller diameter accelerated turbine blade construction involves far less engineering challenges. It is also easier and cheaper to transport, assemble and maintain.
o) Various modifications can be made to the construction, material, arrangement, and operation and still be in the scope of my invention.

CHART A
Power of the wind.

| Power of the wind | | |
|---|---|---|
| Wind speed | Wind power | |
| (m/s) | (Watts/meter2) | |
| 7 | 210.1 | Slowest wind speed a conventional |
| | | turbine will operate in. |
| 8 | 313.6 | |
| 9 | 446.5 | |
| 10 | 612.5 | Typical Wind Farm Location |
| (22 mph) | | Average Annual Wind Speed. |
| 11 | 815.2 | |
| 12 | 1058.4 | |
| 13 | 1345.7 | |
| 14 | 1680.7 | |
| 15 | 2067.2 | |
| 16 | 2508.8 | |
| 17 | 3009.2 | |
| 18 | 3,572.1 | |
| 19 | 4201.1 | |
| 20 | 4900.0 | |
| 21 | 5,672.4 | |
| 22 | 6521.9 | |
| 23 | 7,452.3 | Potential 250% wind speed increase |
| | | from 9 m/sec ambient wind speed. |
| | | A 15 times increase in power density. |

The change in the power available in the wind due to changes in the wind speed or velocity profile is significant; the wind power profile is proportional to the cube of the wind speed profile.

For air density of 1.225 kg/m³, corresponding to dry air at standard atmospheric pressure at sea level at 15° C. The formula for the power per m² in watts=0.5×1.225×v³, where v is the wind speed in m/s. (Note: MPH*0.45=m/s, MPH*0.8684=knots)

Details of the Invention.

Improved Injector Venturi Accelerated, Wind Turbine

A new push-pull injector venturi airflow accelerator with both a front-mounted push funnel and a rear-mounted pull-vacuum funnel with one or typically two or more rear diffuser air bleed-in injector rings, which are strategically located further back than is customary on a larger rear vacuum creating funnel creates very large airflow increases inside the venturi throat without creating eddies or breaking away or stalling the inside and outside airflows. This greatly accelerated airflow drives a hard-shell shrouded high-speed wind turbine and electrical generator to produce much greater electrical power per unit of capital than conventional wind turbines.

The funnels are made with a typical cone angle from the centerline of between 10 degrees to 16 degrees. Small variations beyond these funnel cone angles may also produce similar results.

Various airflow-directing fins, slots or slats can be placed at strategic locations to further direct and smooth ambient airflows in and around the funnel assembly to eliminate or reduce airflow separation, stalls or breakaways.

The push-pull venturi invention design also produces significantly more power than state of the art, pull-only vacuum funnel generators with diffusers and mixing slot such as described in US Patent Number 2009/0230691 A1.

As described in Provisional Patent Number EH 993286360-US which was filed on Jan. 19, 2010 and testing by the Applicants, resulted in increased wind speed of 200% or more. This Venturi Injector push-pull design improvement results in wind speed increases of 200% to 300% or more, thus significantly increasing available ambient wind kinetic energy to drive turbines.

Instead of bringing the turbine up to the higher ambient speed wind area on heavy, high steel masts as conventional wind turbines do, the Improved Injector Venturi Accelerated, Wind Turbine invention is designed to use a lower-height steel, aluminum or other material tube or frame to support fiberglass, carbon fiber and deployable-furling sailcloth, PVC, or similar low cost membrane venturi injector panels to scoop up, capture by both push and pull control and accelerate higher-speed airflows into a more soundly engineered, smaller diameter higher speed multi-bladed turbine which is located much more conveniently closer to the ground, where it can be supported and maintained more easily and cheaply. The wind accelerating device is designed to survive the highest wind events without being prohibitively expensive.

The venturi injector push-pull accelerated airflow is also more actively gust controlled into a large adjustable hard paneled or flexible membrane venturi to ensure the maximum energy is captured from any given ambient wind without overstressing the turbine.

This invention uses low-cost and much larger turbine to venturi funnel ratios, fiberglass or hard shell shroud, deployable-retractable sailcloth, PVC or other membrane outer funnel panels to create larger, sturdier, more efficient controlled push-pull venturi injector to accelerated ambient airflow to approximately 2 to 3 times the ambient wind speed, to rotate a state of the art multi-blade air turbine designed to capture 40-50% or more of the net kinetic energy in the controlled accelerated airflow.

As a front push wind funnel section of the venturi narrows, the ambient air flows more quickly. But if the funnel is made with incorrect proportions it will either not capture sufficient wind energy, or it can create eddies which collapse the smooth airflow, thus robbing power. It can also be too large and cumbersome, thus wasting material.

This invention uses more theoretically sound gentle angled accelerating funnel shapes consisting of;
a) On the front or push side venturi funnel an opening ambient air intake to throat ratio of approximately 150% to 250% of turbine diameter with a cone angle of approximately 10 to 15 degrees or more from the centerline. With a push funnel length of approximately 150% to 300% of the turbine diameter.
b) On the pull or vacuum funnel side the diameter is approximately 1.5 to 5 times larger than the push funnel outer intake diameter. With a rear cone angle of approximately 10 to 15 degrees or more from the centerline. Resulting in an opening post-turbine air exhaust to turbine diameter ratio of 350% to 450% or more of turbine blades diameter. With a rear venturi funnel length of approximately 200% to 350% of the turbine diameter. This is a superior accelerator funnel shape-ratio than current state of the art wind accelerators. Variations of up to 30% of these ratios may prove beneficial.

If steeper cone angles are used on the funnels one or more small injector rings or fixed “slots or slats” surrounding the outer lip is used may redirect ambient airflow around the outside and inside of the venturi funnels to avoid air stalls or breakaways.

One or two or more injector-mixer-diffuser openings and outward-angled accelerator panels around the all or most of the circumference of the rear venturi funnel placed further back than prior art diffusers are sited approximately between one third to three quarters of the funnel assembly length. This allows a small portion of outside ambient air to be accelerated then injected into the rearward flowing accelerated vacuum airstream to stop or reduce airflow stalls, airflow collapses or breakaways inside the funnel, thus allowing a larger more powerful vacuum rear venturi funnel assembly to be deployed. The larger rear venturi funnel injector assembly significantly increases net inside venturi airflow acceleration. Conventional turbine diffuser rear funnels place the openings immediately adjacent to the turbine blades thus reducing potential efficiency.

Steeper funnel cone angles than shown in the drawings can also be utilized provided appropriate airflow controlling smoothing devices such as leading edge slots or slats on the front push venturi funnel outer intake and either larger diffuser injector inlets on the rear venturi funnels or two or more smaller opening diffuser rings or partial rings instead of one. All funnel shapes must ensure the smooth flow of air in and around the structure to avoid airflow breakdowns or airflow stalled areas.

Resulting variable electrical power output can now be controlled and smoothed to match grid requirements using state of the art electrical power control devices provided by third parties and now widely available.

The restrictive description and drawing of the specific examples do not point out what an infringement of this patent would be but are to enable the reader to make and use the invention.

Drawings Figures Included.

### BRIEF DESCRIPTIONS OF THE DRAWINGS

FIG. 1; Single Mixer-Injector Accelerator; Top cross-section view of a cylindrical funneled, 15 degrees angled cones, Improved Injector Venturi Accelerated, Wind Turbine with one rear accelerated injector-diffuser-mixer ring or slots, tube or truss frame supporting a rigid membrane such as fiberglass and-or roller furling sailcloth, or PVC wind accelerating panels on the outer venturi funnel structures. The unique 10-15 degree or more funnel angles from the centerline being shaped so as to accelerate the wind speed without causing the airflow to collapse or break away inside or outside the funnel. The funnel-turbine assembly is mounted on a swiveling base with bearings or wheels to face the prevailing wind in those locations where the wind comes from different directions for prolonged periods. With portions of the funnels being spring loaded or actuator controlled large fabric or fiberglass-carbon-fiber or metal doors which open and close in response to over-speed air flows. An outer shroud may be employed to smooth the outside airflow around the central portion of the Venturi.

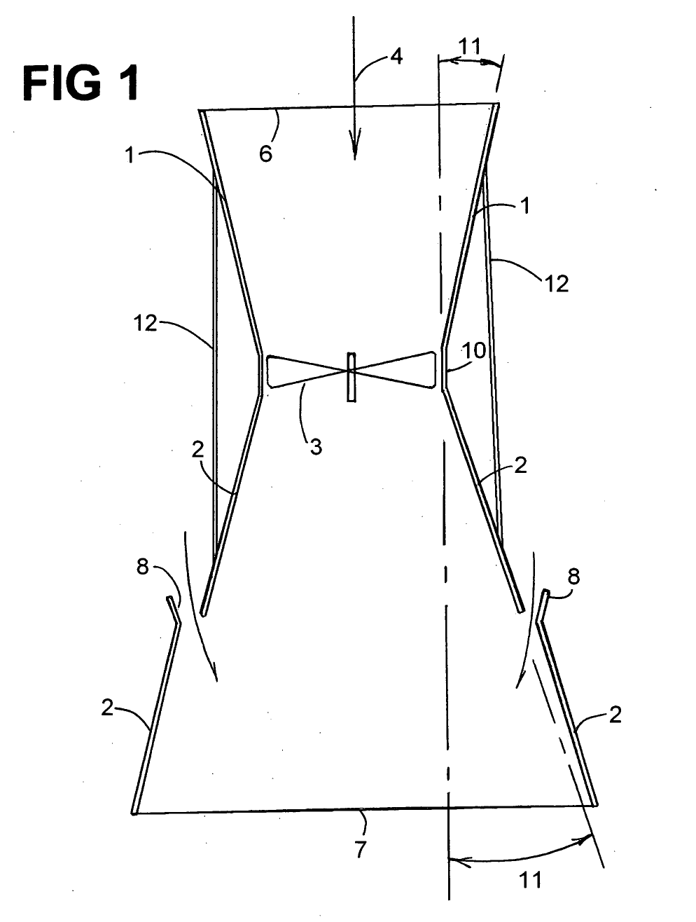

FIG. 2; Double Mixer-Injector Accelerator Top cross-section view of a cylindrical funneled, 10-15 degrees or more angled cones, Improved Injector Venturi Accelerated, Wind Turbine funnel with two injector-mixer-diffuser rings or slots. The funnel angles and diffuser rings being placed and shaped so as to accelerate the wind speed without causing the airflow to collapse or break away inside or outside the venturi funnel. The venturi funnel is made with truss frame supporting a rigid membrane and-or roller furling sailcloth, or PVC wind accelerating venturi panels. Mounted on a swiveling base with bearings or wheels to face the prevailing wind in those locations where the wind comes from different directions for prolonged periods. With portions of the venturi funnels being spring loaded or actuator controlled large fiberglass-plastic or flexible membrane doors which open and close in response to over-speed air flows. An outer shroud may be employed to smooth the outside airflow around the central portion of the Venturi.

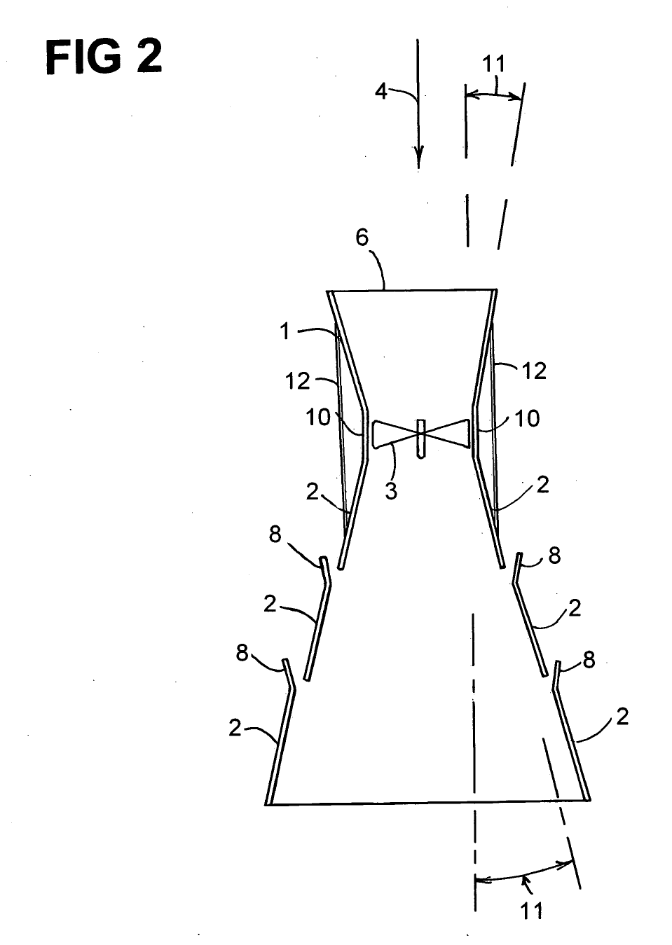

### DESCRIPTIONS OF THE DRAWING COMPONENTS NUMBERING

1. Circular wind-facing Push funnel with 10-15 degrees or more angle sides made from deployable-retractable fiberglass or fabric membrane panels and-or hard shell material, such as carbon fiber or metal, supported by a tube or truss frame (typically steel or aluminum). With hard-shell such as fiberglass or carbon fiber, and-or sailcloth, PVC or other fabric membrane deployable-retractable wind accelerating panels.
2. Rear Circular Pull or vacuum funnel assembly with 10-15 degrees or more angle sides made from hard shell or deployable-retractable fabric membrane panels supported by a tube or truss frame (typically steel or aluminum). With hard-shell such as fiberglass or carbon fiber, close to the turbine, also can have sailcloth, PVC or other fabric membrane deployable-retractable wind accelerating panels with diffuser inlet mixer injection ring or rings with outer air accelerator-injector panels.
3. Circular Multi-blade turbine and generator.
4. Ambient Airflow Direction.
5. Leading Edge Slots or Slats for airflow directing.
6. Inlet diameter of push funnel.
7. Outlet diameter of pull or vacuum funnel.
8. Post turbine vacuum airflow accelerating venturi funnel diffuser-injector-mixer rings with fixed mixing blades.
9. Accelerator panels on the outside of the diffuser-injector-mixer rings.
10. Hard shell wind turbine blades shroud.
11. Funnel cone angle relative to assembly centerline.
12. Optional center portion outer venturi airflow smoothing circular membrane or fiberglass shroud.

Components of the Invention and How They Interact.
A) A wind turbine with propeller blades typically between 20 to 150 foot in diameter, made of multiple propeller blades either fixed or more preferable actively pitch controlled, connected through a shaft to an in-hub electric generator. The drive-train may include a torque limiting fluid or friction coupling. The air turbine blades are shrouded inside a circular hard shell.
B) A airflow assisted venturi consisting of a large hard-shell and-or fabric or membrane push funnel approximately 1.5 to 3 times longer than the diameter of the turbine, with a larger opening facing towards the prevailing wind. The opening facing the ambient wind is sized approximately 1.5 to 2.5 times the size of the turbine diameter. The cone angle of all of the funnel components is typically between 10 to 15 degrees or more from the structure centerline. Rounded corners are used to smooth air flow. The accelerating push funnel is made of a structural frame typically a steel or aluminum tube or truss supporting either a hard shell such as fiberglass or carbon fiber panels and-or a number of roller furled sailcloth, PVC or other suitable membrane panels which can be regularly unfurled and furled or expanded and retracted as needed to control airflow speed by means of a powered doors or roller-furling device and wires or ropes, Hard-shell venturi panels may also be used. Airflow control also can be effected by large hinged airflow-control doors.
C) A large airflow exhaust-pull or vacuum venturi funnel assembly with 10-15 degree or more cone angles is typically made from hard shell materials such as metal, carbon fiber or fiberglass. Rounded corners are used to smooth air flow. The funnels contain deployable-retractable panels made from either hard shell materials or fabric, such as sailcloth or PVC membrane. This airflow pull or vacuum injected funnel assembly approximately is 2.0 to 3.5 times longer than the diameter of the turbine, with a larger exhaust opening facing away from the prevailing wind. The diameter of the opening facing away from the ambient wind is sized approximately 3 to 4.5 times or more the size of the turbine blades diameter. The cone angle of all of the funnel components is typically between 10 to 15 degrees or more from the structure centerline. The accelerating vacuum funnel is made of a structural frame typically a steel or aluminum tube or truss supporting a number of hard shell such as fiberglass or roller furled sailcloth, PVC or other suitable membrane panels which can be regularly unfurled and furled or expanded and retracted as needed to control airflow speeds by means of a hinged door or powered furling device and wires or ropes, also can be made with large hinged wind-control doors. Hard-shell panels may also be used in low and higher pressure areas. Rounded corners are used to smooth air flow.
D) Approximately ⅓^{rd} to ⅔rds of the length of the rear pull section of the venturi assembly one, two or more air bleed-in injector-accelerators, diffuser-mixer openings are situated around the rear venturi funnel to allow a small amount of ambient air to be accelerated and bleed into the inside of the funnel to keep the inside accelerated airflow stable and reduce airflow stalls. Fixed blades inside the injector ring may rotate the injected airflow to create beneficial vortexes inside the vacuum exhaust airflow. A bleed-out diffuser ring may also be installed on the forward push venturi funnel.
E) A large soft bird safety netting is spread to cover venturi funnel openings to ensure birds cannot inadvertently enter the turbine.
F) Passive and active accelerated airflow control mechanisms are deployed to first capture and accelerate airflow to the turbine blades during normal ambient wind speeds, then to progressively adjust or activate to open and spill air from the funnel during high wind events in order to not over-speed the turbine and to protect the funnel structure, shell, fabric and frame from overstressing during extreme wind events. These can typically be made of hinged hard shell doors or conventional sailboat sail-furling devices for the larger outer funnel membrane panels, separate large fabric, fiberglass, carbon fiber or fiberglass or plastic panel doors nearer to the turbine blades which progressively open when the ambient wind speed reaches predetermined speeds or pressure. Similar devices are constructed on the pull side funnel venturi assembly.
G) Outer accelerating panels and fixed vortex generating blades directs the diffuser rings-mixer airflow into the venturi airflow so as to create free vortex airflow.
H) The Improved Injector Venturi Accelerated, Wind Turbine can also have powered swiveling doors directly in front of the turbine blades, facing the wind flow, which can be rotated through 45 degrees to be opened and closed in increments to first direct the airflow onto the blade at a beneficial angle and also progressively reduce the airflow to the turbine blades during extreme high wind events or to close the airflow completely for maintenance.
I) For locations where the ambient wind comes from significantly different directions at different times, the entire turbine-funnel assembly rides on a rotating sub frame or base which has a turntable and or wheeled outer funnel frame components. The Accelerated Controlled Airflow Power Turbine assembly then rotates to face the incoming funnel opening into the prevailing wind whenever sufficient wind is flowing from any particular direction. This action would typically be controlled by a computer with input from wind direction sensors.

Additional Details of the Components of the Invention

The Improved Injector Venturi Accelerated, Wind Turbine with controlled wind funnel push-pull accelerators has one or more of the following components;

Supporting Structure Typically Made of Carbon-Fiber, Steel or Aluminum Pipe or Trusses.

This structure supports;
A) The turbine, wheeled base support structure, generator and control equipment and allows the entire assembly to rotate and point into the prevailing wind.
B) The focusing accelerating push and pull wind funnels with injectors-mixers and wind control features.

The Funnel may have Various Passive Airflow Control Devices, either-or;
a) Panels of porous fabric membranes wind funnel panels, (”shade cloth“) which allow a percentage of wind to pass through the membrane to mitigate sudden torque events on the turbine during wind gusts and persistent high winds.
b) Large fiberglass-carbon fiber or sail cloth, canvas or other fabric or membrane panels which bend or open on hinges during high wind events to automatically spill excess air pressure out of the turbine funnel during gusts and extreme high winds.

The Funnel Accelerator May Have Active Airflow Control Devices.
a) Outer accelerating panels, diffuser mixer-injection rings or slots with fixed mixing blades to direct a portion of the ambient airflow into the exhaust funnel airflow to create vortexes, reduce stalling and airflow disruptions thus increasing net power.
b) Venturi “Roller Furling” “sails” or panels which unfurl during low wind speeds to capture and accelerate the maximum percentage of ambient airflow into the turbine throat by pushing or accelerating the airflow by compression and pulling or vacuum on the downwind side of the turbine. The panels may be wind pressure powered or computer controlled to progressively retract or furl during high winds to lower the speed and amount of air entering the turbine throat to a predetermined maximum.
c) Turbine and electrical generator, hard-shell turbine shroud, sailcloth, PVC fabric, fiberglass, carbon fiber plastic or other suitable membrane covered doors located within the funnel sides, top or walls which are held closed during low wind periods and held by springs, arms or hinges so as to be able to be readily progressively forced open by high wind events thus progressively spilling a controlled amount of air out of the turbine funnel areas.
d) Large controlled powered swiveling blades or doors located directly in front of the turbine blades to first control and direct accelerated wind onto the turbine blades at an angle which better drives the turbines at low wind speeds. Then as wind increases to the design limits of the turbine, the doors begin to progressively close off the airflow to the turbines so as to keep the turbines operating at maximum efficiency, even when the ambient wind speed is flowing above the design limit of the turbine.
e) Movable doors inside the throat area may be utilized to section off any outer venturi funnels portion facing away from the prevailing wind.
f) Pitch controlled turbine blades may be used to help keep the generator within its designed speed and torque limits.

Typical Accelerated Controlled Airflow Wind Power Turbine Components

A) For land based units; Heavy foundations made of concrete and base structures typically made from steel or aluminum to support the venturi air funnel structure, airflow controls and turbine and electrical generators. As well as ballast to anchor the entire structure in a high wind location and counteract the large wind forces. This structure may include a swivel plate and wheels or rails to allow the entire wind accelerator generator structure to rotate to face the different ambient wind directions common in a particular location. For offshore units any suitable platform may be utilized to support the turbine-funnels assembly such as a lighter weight pylons or for deeper waters a semi-submersible platform.

B) Sturdy tube or truss support frames to support the hard-shell, or flexible membrane funnels-venturi accelerator components, able to withstand very highest winds recorded in the location the turbine is situated. The support frame is typically made from welded tube or lattice steel pipe or aluminum. The venturi injector funnel will typically be round in cross section.

C) Either hard-shell such as fiberglass or carbon fiber, and-or fabric or other membrane sails and panels attached to the frame either temporarily or permanently. If utilizing fabric panels they will be supported using similar components to sailboat roller furling sail technology. With powered furling-unfurling devices to deploy the fabric panels fully during lower winds and progressively reduce and control the wind concentrating effect forces during wind gusts and during longer term high wind events.

D) Computer controlled servos and motors to repeatedly progressively open and close venturi doors and panels to manage low and high wind flows into the turbine. The computer responds to a number of sensors located in the ambient air stream, the funnel and turbine to fully deploy the funnel panels to create the maximum wind energy recovery from any given lower speed airflow and to furl or progressively close the funnel panels during high wind gusts and storms.

E) Wind turbine to capture the mechanical energy of the accelerated airstreams and turn the energy into shaft power to turn an electricity generator. The mechanical load of the generator is controlled by a feedback control to maintain a relatively constant rotational frequency of the shaft of the generator.

F) Pitch regulated wind power turbine machines featuring an active control system, which senses blade position, measures output power and instructs appropriate changes of blade pitch.

G) Turbine over-speed control is exerted in three main ways: various venturi wind-control doors opening and closing, aerodynamic stalling or blade furling, and mechanical braking.

H) Conventional current state of the art electrical generators, controllers and electrical distribution systems to create and distribute electricity generated by the wind turbine.

All venturi funnels components with cone angles typically between 10 to 15 degrees or greater from the centerline. Rounded corners are used to smooth air flow.

Alternative Ways of Doing It.
a) For offshore wind farms the Improved Injector Venturi Accelerated, Wind Turbine can be constructed on top of in-situ piles or platforms such as modified jack-up rig systems as used in the oil and gas industry, or in deeper water on securely anchored barges or semi-submersible floating platforms.
b) The direction and shape of the hard-shell and-or flexible membrane panels size, opening and closing and shape, and cone angles can be quite varied and still achieve a similar airflow accelerating effect. The Venturi can be non-circular at the front and rear openings and still achieve similar results.

### INDUSTRIAL APPLICABILITY

This invention achieves a very significant increase of power output of a wind generator per unit of capital employed by focusing, accelerating and controlling natural ambient airflows using both push and pull funnel-diffusers to accelerate wind speed by 200% to 300% or more utilizing a collection of inexpensive materials such as steel, fiberglass, carbon fiber, sailcloth, PVC coated vinyl fabric, or other hard or fabric membrane panels, which can include conventional hinged hard venturi panels and-or sailboat technology roller furling devices, airflow control devices and methods easily implemented to form a more powerful, cheaper wind accelerating push-pull funnels-duct diffuser assembly

The venturi accelerator device has strategically placed diffuser rings or injectors, deployable-retractable funnel panels made from practical, available inexpensive hard shell fiberglass or other hard material or flexible membrane-unfurling and furling control technology, using off the shelf roller furling systems, and powered or wind opening wind control doors and panels, while also providing for better controlling high airflow events. The wind power generating device of the present invention is very flexible in design to capture more ambient low and high speed ambient wind energy and provide higher levels of power generation capacity from any given ambient airflow in a sturdy, survivable structure.

This generator can during high wind events provide excess electrical power than contracted to feed the electrical grid. This excess power could be directed to power a pumped hydro electricity storage scheme, a nearby water desalinator to make fresh water or to power an electrolyzer used to generate hydrogen from water.

### PRIOR ART

P. Sterling; Application Number AO Provisional Patent EH 993286360-US, which was filed on Jan. 19, 2010

P. Sterling Application Number AO Provisional Patent Number EH 993289701-US, which was filed on Sep. 9, 2009

Application Ser. No. 12/236,249 Publication number :US 2009/0230691 A1 Filing date: Sep. 23, 2008. Walter M. Presz, J R., Michael J. Werle

U.S. Pat. No. 6,756,696 Yuji Ohya et al Jun. 29, 2004

U.S. Pat. No. 6,981,839. Leon Fan Jan. 3, 2006. Wind Power Generator.

U.S. Pat. No. 7,368,828 B1 Calhoon. May 6, 2008 Wind energy System.

U.S. Pat. No. 6,984,899 B1. Pahl W. Rice. Jan. 10, 2006. Wind Dam electric generator and method

U.S. Pat. No. 5,982,046. Vu Xuan Minh. Nov. 9, 1999 Wind power plant with an integrated acceleration system.

U.S. Pat. No. 4,288,200. Louis R. O'Hare. Sep. 8, 1981 Wind Tower Turbine.

U.S. Pat. No. 6,749,393. Yevgeniya Sosonkina. Jun. 15, 2004 . Wind power plant.

U.S. Pat. No. 6,981,839. Leon Fan. Jan. 3, 2006. Wind powered turbine in a tunnel.

U.S. Pat. No. 7,189,050. Sellman. Mar. 13, 2007. Cross-flow wind turbine.

U.S. Ser. No. 12/283,776. Al Kuljack. Sep. 16, 2008 Wind Catcher and accelerator for generating electricity.

U.S. Pat. No. 7,218,011 Clement Hiel et al. Issue date: May 15, 2007

U.S. Pat. No. 4,422,820. Jerome Kirsch, Edward Markow Issue date: Dec. 27, 1983

U.S. Pat. No. 4,075,500 Richard A. Oman, Kenneth M. Foreman Issue date: Feb. 21, 1978

U.S. Pat. No. 4,482,290 Issue date: Nov. 13, 1984. Kenneth M. Foreman, Barry L. Gilbert

Application Ser. No. 10/495,502 Filing date: Nov. 19, 2002

U.S. Pat. No. 4,132,499 Issue date: Jan. 2, 1979. Jan. 2, 1979. Ozer Igra

We claim:

1. a lower cost method of capturing and generating a level of wind power nearer to the betz limit for an axial flow aerodynamically designed wind turbine, of the compound venturi injector type having both forward facing flared inlet push ducts of a larger diameter than the turbine impeller blades, a hard-shell turbine shroud and an impeller downstream having a ring of turbine impeller blades, and a much larger exhaust rearward exhaust pull duct assembly of a larger diameter than the turbine impeller blades and pull venturi funnel outer diameter with one or more accelerated diffuser inlet mixer rings placed at least ⅓^{rd} of the length of the rear venturi funnel. All venturi funnels with cone angles typically between 10 to 15 degrees or greater from the centerline. With rounded corners to smooth air flow. All inlet ducts and diffuser ring outer openings and rear exhaust have attached soft bird netting covers to eliminate avian deaths.

2. An improved safer method of extracting energy from wind power that is more sturdy, efficient and less costly than existing state of the art using a strong, survivable re-configurable venturi funnels structure with injectors to control airflow. Composing in a wind turbine a shrouded reaction turbine comprising blades for receiving the wind and deriving mechanical and hence electrical power therefrom and both push and pull airflow speed augmenter venturi ducts means for accelerating and increasing the volume of the ambient airflow to a much higher speed, the venturi funnels with cone angles typically between 10 to 15 degrees or greater from the centerline. The increased speed airflow is directed over the ducted turbine blades to create mechanical rotational power which drives an electrical generator. The first venturi push duct facing the ambient wind has an outer diameter at least 1.5 times larger than the diameter of the turbine blades and a typical cone angle from the centerline of between 10 degrees to 15 degrees or more. The second rear-facing pull or vacuum duct assembly has an outer diameter at least 2.5 times larger than the inlet diameter of the turbine blades and a larger diameter than the diameter of the outer diameter of the first push duct funnel and can be as much as 5 times larger diameter. The second rear facing vacuum or pull duct funnel has one or more mixing diffuser rings placed at least one third of the distance behind the turbine with outer accelerating panels and vortex creating blades to accelerate and rotate exhaust flows from the turbine blades into a free vortex and reduce airflow disruptions inside the rear funnel duct boundaries.

3. An improved efficiency ambient wind accelerated wind turbine, the method comprising:
a) An axial flow wind turbine having an upstream direction and a downstream direction in a wind stream with airflow push and pull venturi funnels.
b) A venturi capturing directing and accelerating primary ambient wind stream with a windward facing push funnel and through a turbine shroud and rotating impeller inside the shroud and a larger rearward facing injector venturi funnel whereby kinetic energy is transferred from the accelerated airflow to a turbine impeller and electrical generator.
c) A rear funnel component of the venturi directing the exhaust airstream after exiting the turbine blades into a vacuum creating expanding rearward pull duct-funnel injector assembly, connected to the turbine shroud wherein the secondary exhaust airstream contains more rearward energy than the exhaust airstream immediately after it exits the turbine blades.
d) Diffusers injecting, directing and accelerating a portion of the airflow from outside of the rearward facing duct, which has not passed through the turbine, into the vacuum airflow at a higher speed and at an angle to mix with the exhaust airflow from the turbine blades wherein the secondary airstream mixes with the injected diffuser ring air to reduce airflow interruptions inside the duct and rotate the inside air vortex thus increasing recovered turbine power, wherein the outer diameter of the said inlet duct is greater than the diameter of the turbine blades with cone angles typically between 10 to 15 degrees or greater from the centerline.
e) Either, one, two or more mixer diffuser-injector rings with fixed vortex generator blades in the rear funnels behind the exit of the turbine blades which cause the bleed in or injected airflow to rotate in the same direction as the airflow emanating from the turbine blades.
f) Utilizing the large diameter axial flow wind turbine rear pull duct-funnel venturi as a air mixer-suction pump due to positioning of the mixer diffuser rings and angled diffuser ring blades relative to the funnel such that high and low energy air, mix to create vortexes to enhance airflow speed through the turbine blades.
g) A venturi where one or more slots or flaps around the intake venturi outer rim directs ambient airflow to eliminate or reduce boundary layer airflow disruptions around the outside of the ducts assembly. Venturi fixed diffuser duct shell components made of hard shell material close to the turbine blades with rounded corners. Inlet and outlet diffuser outer ducts funnel panels which are deployable and retractable made of hard shell such as fiberglass or flexible membrane material. All inlet ducts and diffuser ring outer openings and rear exhaust have attached soft bird netting covers to eliminate avian deaths.
